(19) United States
(12) Patent Application Publication
(10) Pub. No.: US 2023/0239387 A1
(43) Pub. Date: Jul. 27, 2023

(54) HOLDER FOR PORTABLE TERMINAL

(71) Applicant: Yeosin YOON, Seoul (KR)

(72) Inventor: Yeosin YOON, Seoul (KR)

(21) Appl. No.: 17/691,601

(22) Filed: Mar. 10, 2022

(30) Foreign Application Priority Data
Jan. 25, 2022 (KR) 10-2022-0011001

(51) Int. Cl. H04M 1/04

(52) U.S. Cl. CPC H04M 1/04

(57) ABSTRACT

Provided is a holder for a portable terminal. According to one aspect of the present invention, a holder for a portable terminal, which includes a base unit coupled to a portable terminal, a cover unit detachably coupled to one surface of the base unit, and a holder unit which is interposed between the base unit and the cover unit and supports a finger of a user, is provided.

### CROSS-REFERENCE TO RELATED APPLICATION

This application claims priority to and the benefit of Korean Patent Application No. 10-2022-0011001 filed on Jan. 25, 2022, the disclosure of which is incorporated herein by reference in its entirety.

### BACKGROUND

### 1. Field of the Invention

The present invention relates to a holder for a portable terminal.

### 2. Discussion of Related Art

Since portable terminals such as smartphones are generally becoming thinner and lighter, portability of portable terminals is gradually improving but there is a problem in that a portable terminal easily escapes from the hand of a user when the user carries the portable terminal while holding the portable terminal with his or her hand.

In addition, since image content for portable terminals is actively developed and supplied, there are many cases where image content such as movies or dramas is watched using portable terminals, and to this end, a user should hold a portable terminal with his or her hand and maintain a proper angle in order to watch a display of the portable terminal well. When such a state is maintained for a long time, there is a problem in that the user's hand, shoulder, neck, and the like are overloaded.

Accordingly, development and ideas for devices for stably holding and setting a portable terminal are necessary.

### SUMMARY OF THE INVENTION

The present invention is directed to providing a holder for a portable terminal, which allows a user to insert a finger into the holder to support the holder so that a portable terminal is stably held, is coupled to the portable terminal, and at the same time enables a reduction in volume thereof so that the holder for a portable terminal is easy to carry when a holding function thereof is not used.

According to an aspect of the present invention, there is provided a holder for a portable terminal which includes a base unit coupled to a portable terminal, a cover unit detachably coupled to one surface of the base unit, and a holder unit which is interposed between the base unit and the cover unit and supports a finger of a user.

The holder for a portable terminal may further include a coupling unit which supports the holder unit on the cover unit.

The holder for a portable terminal may further include an anti-twist unit which is interposed between the cover unit and the coupling unit and prevents the holder unit from being twisted.

A through hole may be formed in the holder unit, and the anti-twist unit may include an anti-twist protrusion which is inserted into the through hole and supports the holder unit.

Any one of the base unit and the cover unit may include a coupling groove, and the other of the base unit and the cover unit may include a coupling protrusion formed to correspond to the coupling groove and inserted into the coupling groove to couple the cover unit and the base unit.

The coupling groove may be provided with a support rail which extends from the coupling groove and provides a path through which the coupling protrusion inserted into the coupling groove is movable in order to support coupling of the cover unit and the base unit.

The holder for a portable terminal may further include separation prevention units which are formed on the cover unit and the base unit and prevent the cover unit from being separated from the base unit.

The separation prevention unit may include a separation prevention groove formed in the coupling protrusion and a separation prevention protrusion formed on the support rail to correspond to the separation prevention groove.

An insertion groove into which one side of the cover unit is inserted to set the portable terminal to be inclined at a preset angle with respect to a placement surface may be formed in the base unit.

The base unit may include a first inclined surface formed on an outer circumferential surface of the base unit so that a finger insertion space through which the finger of the user is inserted is formed between the base unit and the cover unit.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating a use state of a holder for a portable terminal according to one embodiment of the present invention;

FIGS. 2 and 3 are exploded perspective views illustrating the holder for a portable terminal according to one embodiment of the present invention;

FIG. 4 is a view illustrating a coupled state of the holder for a portable terminal according to one embodiment of the present invention;

FIG. 5 is a set of views illustrating a set state of the holder for a portable terminal according to one embodiment of the present invention; and

FIG. 6 is a set of views illustrating a coupled state of a holder for a portable terminal and a state in which a holder and a case are integrally injection-molded according to one embodiment of the present invention.

### DETAILED DESCRIPTION OF EXEMPLARY EMBODIMENTS

Since the present invention allows for various changes and numerous embodiments, specific embodiments will be illustrated in the accompanying drawings and described in the detailed description. However, this is not intended to limit the present invention to the specific embodiments, and it is to be appreciated that all changes, equivalents, and substitutions that do not depart from the spirit and technical scope of the present invention are encompassed in the present invention. In the description of the embodiments, detailed descriptions of the related art are omitted when it is deemed that they may unnecessarily obscure the gist of the present invention.

Although the terms “first,” “second,” and the like may be used herein to describe various elements, these elements should not be limited by these terms. These terms are only used to distinguish one element from another element.

The terminology used herein is for the purpose of describing particular embodiments only and is not intended to limit the present invention. The singular forms are intended to include the plural forms, unless the context clearly indicates otherwise. In the present specification, it should be further understood that the terms “comprise,” “comprising,” “include,” or “including,” when used herein, specify the presence of stated features, numbers, steps, operations, elements, and/or components but do not preclude the presence or addition of one or more other features, numbers, steps, operations, elements, components, or groups thereof.

In addition, the terms “first,” “second,” and the like used herein are only identification symbols for distinguishing components which are the same or correspond to each other, and the components which are the same or correspond to each other are not limited by the terms “first,” “second,” and the like.

In addition, the term “coupled” is not only used to refer to a case in which components are physically in contact with each other but is also used as a concept encompassing a case in which another component is interposed therebetween and is in contact with each of the components.

Hereinafter, embodiments of a holder 100 for a portable terminal according to the present invention will be described with reference to the accompanying drawings, and in the description with reference to the accompanying drawings, the components which are the same or correspond to each other will be denoted by the same reference numerals, and redundant descriptions will be omitted.

According to the present embodiment, the holder 100 for a portable terminal including a base unit 110 which may be coupled to a portable terminal 10, a cover unit 130 detachably coupled to one surface of the base unit 110, and a holder unit 140 which is interposed between the base unit 110 and the cover unit 130 and supports a finger of a user is provided.

According to the present invention, the base unit 110 is coupled to the portable terminal 10, and the user inserts the finger into the holder unit 140 interposed between the base unit 110 and the cover unit 130 so that the portable terminal 10 may be stably held.

For example, when the holder 100 for a portable terminal is coupled to a rear surface of the portable terminal 10, the user may manipulate a display using a thumb and insert an index or middle finger thereinto to stably support the portable terminal 10 at the same time.

In addition, in the present embodiment, the cover unit 130 is attachable to and detachable from the base unit 110, and when a holding function thereof is not used, the cover unit 130 may be coupled to the base unit 110 in a folding manner to reduce a volume thereof.

As an example, in the present embodiment, the portable terminal 10 may be formed to have a small thickness to be wirelessly charged in a magnetic induction manner, and since the holder 100 for a portable terminal does not need to be separated for wireless charging, the wireless charging may be performed more easily. In addition, in the present embodiment, the holder 100 for a portable terminal is easy to carry due to its small thickness.

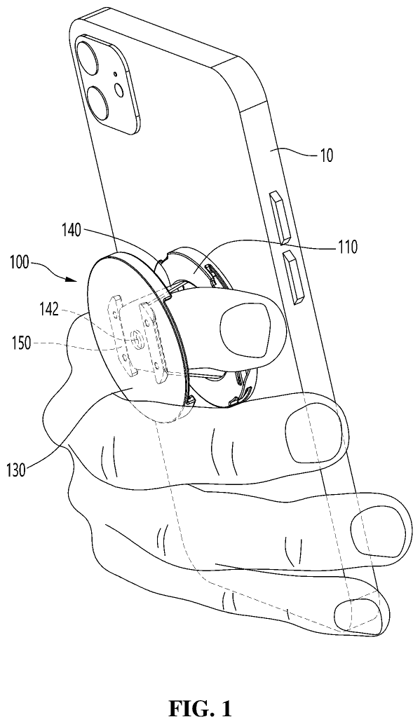

Hereinafter, components of the holder 100 for a portable terminal according to the present embodiment will described with reference to FIGS. 1 to 6.

As illustrated in FIGS. 1, 4, and 5, the base unit 110 may be coupled to one surface of the portable terminal 10. More specifically, the base unit 110 may be coupled to a rear surface of the portable terminal 10 so as not to interfere with the user's manipulation of the portable terminal 10.

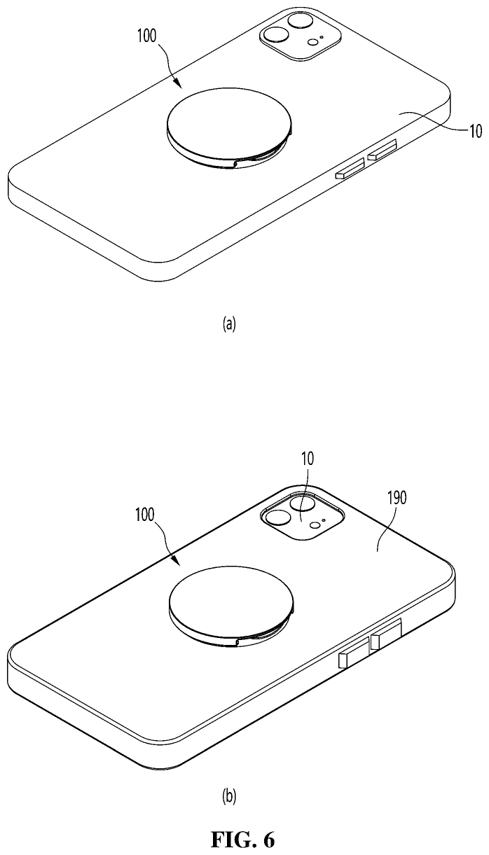

That is, as illustrated in FIG. 6A, the base unit 110 may be coupled to the rear surface of the portable terminal 10, and an adhesive member such as a glue, a sticker, or a double-sided tape may be formed between and attached to the base unit 110 and the rear surface of the portable terminal 10 so that the base unit 110 and the rear surface of the portable terminal 10 may also be coupled.

Meanwhile, the holder 100 for a portable terminal may further include a case 190 which absorbs an impact from the outside to prevent the portable terminal 10 from being damaged. In this case, as illustrated in FIG. 6B, the base unit 110 may be integrally injection-molded with the case 190 and coupled to portable terminal 10.

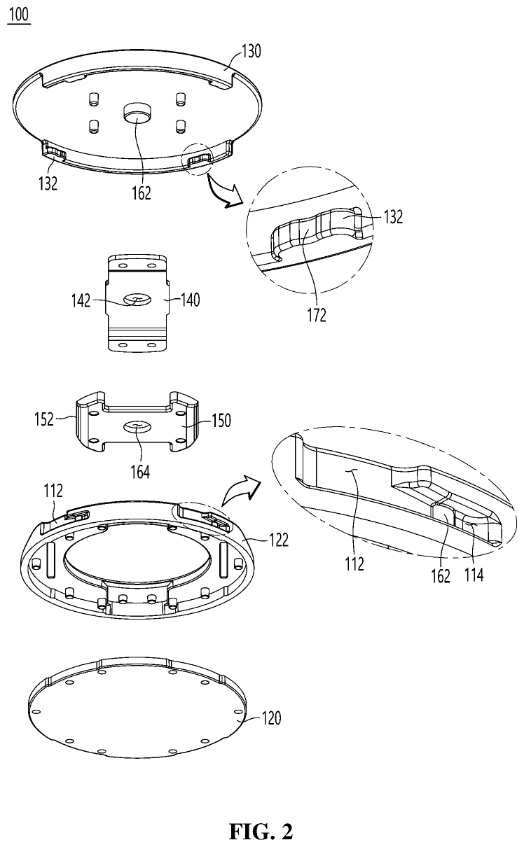

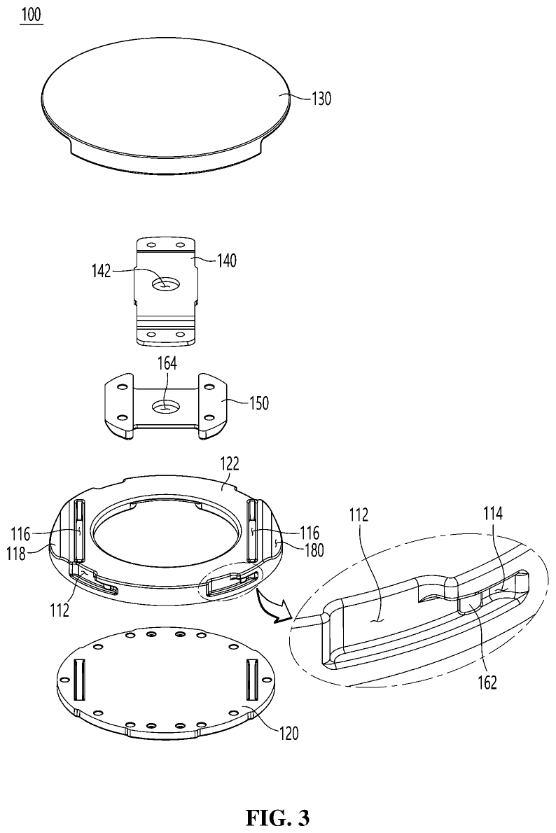

As illustrated in FIGS. 2 and 3, the base unit 110 may include a base plate 120, of which one surface may be coupled to the portable terminal 10 or which may be integrally injection-molded with the case 190 and coupled to the portable terminal 10, and a base cap 122 which may be coupled to the other surface of the base plate 120.

According to one embodiment, a base plate 120 and a base cap 122 may be formed in circular shapes.

The base plate 120 may be mechanically coupled to the portable terminal 10 or coupled to the portable terminal 10 by an adhesive member, a protrusion, which may be coupled to a groove, may be formed on the base cap 122, and the groove corresponding to the protrusion, which may be formed on the base cap 122, may be formed on the base plate 120. In this case, the protrusion and the corresponding groove may be provided as a plurality of pairs thereof, and the base cap 122 and the base plate 120 may be coupled in an insertion manner using the formed protrusions and grooves.

In the base cap 122 and the base plate 120, a protrusion and a corresponding groove capable of supporting both ends of a holder unit 140 may be formed. Such a coupling structure of the base cap 122, the base plate 120, and the holder unit 140 has higher durability than a coupling structure using an adhesive member such as a glue, a sticker, or a double-sided tape.

Any one of a base unit 110 and a cover unit 130 may include a coupling groove 112, and the other may include a coupling protrusion 133 which is formed to correspond to the coupling groove 112 and is inserted into the coupling groove 112 to couple the cover unit 130 and the base unit 110.

The coupling groove 112 may be provided with a support rail 114 which extends from the coupling groove 112 and provides a path through which the coupling protrusion 133 inserted into coupling groove 112 may move in a sliding manner in order to support the coupling of the cover unit 130 and the base unit 110.

In addition, a space in which a coupling unit 150, which will be described below, may be accommodated when the cover unit 130 is coupled to the base cap 122 may be provided in the base cap 122. Accordingly, in the present embodiment, even when the cover unit 130 and the base unit 110 are coupled, since the coupling unit 150 is inserted into the space formed in the base cap 122, a small thickness can be achieved.

As illustrated in FIGS. 1 and 6, the cover unit 130 may be detachably coupled to one surface of the base unit 110. In addition, as illustrated in FIGS. 2 and 3, the cover unit 130 may also be detachably coupled to one surface of the base cap 122.

In addition, the cover unit 130 may be formed in a circular shape corresponding to the base plate 120 and the base cap 122.

As illustrated in FIGS. 2 and 3, the holder unit 140 may be interposed between the base unit 110 and the cover unit 130. In addition, as illustrated in FIG. 1, the holder unit 140 may be interposed between the base unit 110 and the cover unit 130 and support a finger of a user.

As one embodiment, a holder unit 140 may be formed of an elastic material such as a silicone band. More specifically, the holder unit 140 may be formed of the elastic material having an elastic reinforcing force and may not only more strongly support the finger of a user but may also support a finger regardless of a thickness of the finger.

The holder unit 140 may provide an elastic force which pulls a cover unit 130 toward a base unit 110 in a state in which one side of the cover unit 130 is inserted into an insertion groove 116, which will be described below, so that the cover unit 130 may be more stably inserted into the insertion groove 116.

Since the holder unit 140 is contracted when a base unit 110 and a cover unit 130 are coupled, a volume thereof may decrease, and thus the holder unit 140 is easily accommodated between the base unit 110 and the cover unit 130.

As another embodiment, a holder unit 140 may also be formed using a connection member in a strap shape and may be accommodated in a folding or rolling manner when a base unit 110 and a cover unit 130 are coupled.

Meanwhile, as illustrated in FIGS. 1, 4, and 5, both sides of the holder unit 140 may be supported by the base unit 110. According to one embodiment, both sides of a holder unit 140 may be inserted between and supported by a base plate 120 and a base cap 122. Since holes are formed in both end portions of the holder unit 140, the holder unit 140 may be supported by protrusions and corresponding grooves which may be formed in the base cap 122 and the base plate 120.

As illustrated in FIGS. 1 to 5, a coupling unit 150 may support the holder unit 140 on the cover unit 130. According to one embodiment, a coupling unit 150 may be formed in an “H” shape.

In addition, a path through which a holder unit 140 is insertable may be formed in the coupling unit 150. In this case, the holder unit 140 may be inserted into the path formed in the coupling unit 150 and supported by a cover unit 130 coupled to the coupling unit 150.

A protrusion may be formed on any one of the coupling unit 150 and the cover unit 130, and a groove corresponding to the protrusion may be formed in the other of the coupling unit 150 and the cover unit 130. In this case, the coupling unit 150 may be coupled to the cover unit 130 in an insertion coupling manner of the protrusion and the groove.

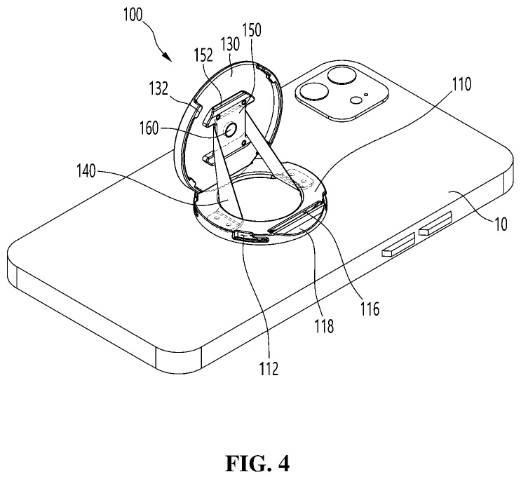

Meanwhile, the holder unit 140 may be twisted due to repeated coupling and separation of the cover unit 130 and a base unit 110. Accordingly, as illustrated in FIG. 4, the holder 100 for a portable terminal may further include an anti-twist unit 160 which is interposed between the cover unit 130 and the coupling unit 150 and prevents the holder unit 140 from being twisted.

As an example, a through hole 142 may be formed in the holder unit 140, and the anti-twist unit 160 may include an anti-twist protrusion 162 which is inserted into the through hole 142 and supports the holder unit 140, and the anti-twist protrusion 162 may be integrally injection molded with the cover unit 130 as illustrated in FIG. 2. In addition, although not illustrated in the drawing, the anti-twist protrusion 162 may also be integrally injection-molded with the coupling unit 150.

Meanwhile, as illustrated in FIGS. 2 and 3, an anti-twist hole 164 may be formed in the coupling unit 150. In this case, the anti-twist protrusion 162 may also be inserted into the through hole 142 and the anti-twist hole 164 to support the holder unit 140 more strongly.

Since the holder unit 140 may also be torn due to repeated coupling and separation of the cover unit 130 and the base unit 110, as illustrated in FIGS. 2 to 4, a width of a portion of the holder unit 140 that surrounds the through hole 142 may be greater than a portion of the holder unit 140 that does not surround the through hole 142 in order to prevent tearing of the holder unit 140 around the through hole 142.

As described above, since the holder unit 140 is formed so that the width is large, durability can be improved, tearing can be prevented, and thus a use lifetime of the holder 100 for a portable terminal can increase.

Meanwhile, any one of the base unit 110 and the cover unit 130 may include a coupling groove 112, and the other of the base unit 110 and the cover unit 130 may include a coupling protrusion 133 formed to correspond to the coupling groove 112 and inserted into the coupling groove 112 to couple the cover unit 130 and the base unit 110.

As an example, as illustrated in FIGS. 1 to 5, the coupling groove 112 may be formed in an outer circumferential surface of the base unit 110. Accordingly, the coupling protrusion 133 may be formed on the cover unit 130 to correspond to the coupling groove 112. In this case, the coupling protrusion 133 may be inserted into the coupling groove 112 to couple the cover unit 130 to the base unit 110.

As another example, the base unit 110 may also include the coupling protrusion 133, and the cover unit 130 may include a coupling groove corresponding to the coupling protrusion 133.

The coupling groove 112 and the coupling protrusion 133 may be provided as a plurality of coupling grooves 112 and a plurality of coupling protrusions 133, and one sides of the coupling grooves 112 may be open for the coupling protrusions 133 to be inserted into the coupling grooves 112.

In addition, the coupling grooves 112 may be provided with support rails 114 which extend in the coupling grooves 112 and provide paths through which the coupling protrusions 133 inserted into coupling grooves 112 may move in a sliding manner in order to support coupling of the cover unit 130 and the base unit 110. In addition, the plurality of support rails may be provided to correspond to the plurality of coupling grooves 112.

A direction in which the cover unit 130 is coupled to the base unit 110 may be determined according to a direction in which the support rail extends from the coupling groove 112, and the coupling direction may be clockwise or counterclockwise.

Meanwhile, separation prevention units 170 may be formed on the cover unit 130 and the base unit 110 and prevent the cover unit 130 from being separated from the base unit 110. More specifically, the separation prevention units 170 may include a separation prevention groove 172 formed in the coupling protrusion 133 and a separation prevention protrusion 174 formed on the support rail 114 to correspond to the separation prevention groove 172.

According to one embodiment, a separation prevention groove 172 may be formed to be recessed in a central portion of a coupling protrusion 133. A separation prevention protrusion 174 may be formed to protrude at a position spaced apart from an end portion of a support rail 114 toward a coupling groove 112 by half a length of the coupling protrusion 133.

As illustrated in FIGS. 2 to 5, an insertion groove 116 into which one side of a cover unit 130 is inserted to set a portable terminal 10 to be inclined at a predetermined angle with respect to a placement surface may be formed in a base unit 110. That is, the insertion groove 116 may allow the base unit 110 to accommodate one side of the cover unit 130 therein, and accordingly, a holder 100 for a portable terminal may have a shape on which the portable terminal 10 can be placed.

According to one embodiment, an insertion groove 116 may be provided as a plurality of insertion grooves 116, and the plurality of insertion grooves 116 are formed at different angles to support a portable terminal 10 at different angles with respect to a placement surface.

A base unit 110 may include a first inclined surface 118 formed on an outer circumferential surface of the base unit 110 so that a finger insertion space 180 through which a finger of a user may be inserted is formed between the base unit 110 and a cover unit 130. The first inclined surface 118 allows the user to easily hold the cover unit 130 in a state in which the base unit 110 and the cover unit 130 are coupled.

A coupling unit 150 may include a second inclined surface 152 which is obliquely formed on an outer circumference and allows the finger of the user to be inserted without being hooked. In addition, the second inclined surface 152 may be formed in the same direction as the first inclined surface 118, and along with the first inclined surface 118, the second inclined surface 152 can minimize the finger of the user being hooked on each member in a process in which the finger of the user is inserted between the base unit 110 and the cover unit 130.

Meanwhile, a holder 100 for a portable terminal may further include a decoration part which is formed on the cover unit 130 to decorate the cover unit 130. More specifically, a print, on which at least any one of text and an image is printed, may be attached to the decoration part, or the decoration part may be carved through any one of embossing and engraving. The decoration part may provide an aesthetic effect or may be used for propagating advertisement and information.

Hereinafter, a method of using the holder 100 for a portable terminal according to the present invention will be described with reference to FIGS. 1 to 6.

When a holding function of the holder 100 for a portable terminal is used, first, the holder 100 for a portable terminal is coupled to the portable terminal 10 as illustrated in FIG. 6A, or the holder 100 for a portable terminal integrally injection-molded with the case 190 covers the portable terminal 10 as illustrated in FIG. 6B.

Next, as illustrated in FIG. 1, the cover unit 130 is separated from the base unit 110. Specifically, the user inserts the finger into the finger insertion space 180 provided by the first inclined surface 118 to support the cover unit 130 and rotates the coupling protrusion 133 so that the coupling protrusion 133 is output through one open side of the coupling groove 112 along the support rail 114. Since the holder unit 140 is interposed between the separated cover unit 130 and base unit 110, the user may insert the finger between the holder unit 140, and the finger of the user may be supported by the base unit 110, the cover unit 130, and the holder unit 140.

Accordingly, the user can stably hold the portable terminal 10 with the remaining fingers excluding the palm and the thumb in a state in which the finger is supported according to the embodiment and can stably manipulate a display while holding the portable terminal 10.

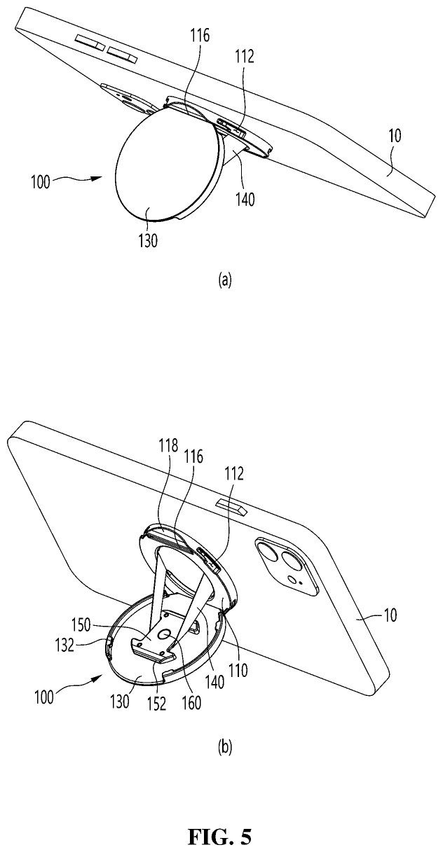

In addition, when a placing function of the holder 100 for a portable terminal is used, as illustrated in FIG. 4, one surface of the cover unit 130 is inserted into the insertion groove 116. Accordingly, the holder 100 for a portable terminal may set the portable terminal 10 on the placement surface, and the user may selectively set the holder 100 for a portable terminal in one of two forms as illustrated in FIGS. 5A and 5B.

According to the present invention, since a user inserts her or his finger to support the holder for a portable terminal, the portable terminal can be stably held, and since the holder is coupled to the portable terminal, and volume is reduced at the same time when a holding function of the holder is not used, the holder for a portable terminal is easy to carry.

While one embodiment of the present invention has been described above, the present invention may be variously modified and changed by those skilled in the art by adding, changing, and removing components without departing from the spirit of the present invention, and these will also fall within the scope of the present invention.

What is claimed is:

1. A holder for a portable terminal, the holder comprising:
a base unit coupled to a portable terminal;
a cover unit detachably coupled to one surface of the base unit; and
a holder unit which is interposed between the base unit and the cover unit and supports a finger of a user.

2. The holder of claim 1, further comprising a coupling unit which supports the holder unit on the cover unit.

3. The holder of claim 2, further comprising an anti-twist unit which is interposed between the cover unit and the coupling unit and prevents the holder unit from being twisted.

4. The holder of claim 3, wherein:
a through hole (142) is formed in the holder unit; and
the anti-twist unit includes an anti-twist protrusion which is inserted into the through hole (142) and supports the holder unit.

5. The holder of claim 1, wherein:
any one of the base unit and the cover unit includes a coupling groove; and
the other of the base unit and the cover unit includes a coupling protrusion formed to correspond to the coupling groove and inserted into the coupling groove to couple the cover unit and the base unit.

6. The holder of claim 5, wherein the coupling groove is provided with a support rail which extends from the coupling groove and provides a path through which the coupling protrusion inserted into the coupling groove is movable in order to support coupling of the cover unit and the base unit.

7. The holder of claim 6, further comprising separation prevention units which are formed on the cover unit and the base unit and prevent the cover unit from being separated from the base unit.

8. The holder of claim 7, wherein the separation prevention unit includes:
a separation prevention groove formed in the coupling protrusion; and
a separation prevention protrusion formed on the support rail to correspond to the separation prevention groove.

9. The holder of claim 1, wherein an insertion groove into which one side of the cover unit is inserted to set the portable terminal to be inclined at a preset angle with respect to a placement surface is formed in the base unit.

10. The holder of claim 1, wherein the base unit includes a first inclined surface formed on an outer circumferential surface of the base unit so that a finger insertion space through which the finger of the user is inserted is formed between the base unit and the cover unit.
